(19) United States
(12) Patent Application Publication
(10) Pub. No.: US 2011/0165549 A1
(43) Pub. Date: Jul. 7, 2011

(54) CHILDREN'S STORY AUDIO/VIDEO PLAYING DEVICE

(76) Inventor: Kuang-Tsai Hao, Taipei (TW)

(21) Appl. No.: 12/652,781

(22) Filed: Jan. 6, 2010

(51) Int. Cl. G09B 5/00

(52) U.S. Cl. 434/317

(57) ABSTRACT

A children's story audio/video playing device includes a playing device body having a main board, a display device, a speaker, an audio receiver, a user operating device, at least one connector and power supply, and the main board includes a central processing unit, a display engine, an audio processing unit, a general purpose I/O; a USB host, a memory card controller, a power management controller, a network controller, a direct memory access unit, a program storage unit, a real time clock unit, and a memory controller, such that the children's story audio/video playing device can play words, pictures, animation images and sounds and allow users to record the played audio content.

### FIELD OF THE INVENTION

The present invention relates to a children's story audio/video playing device, in particular to a design of a children's story audio/video playing device capable of playing texts, graphics, animation images and sounds.

### BACKGROUND OF THE INVENTION

Traditional children story books just use words and pictures printed on paper to show contents of the books, and thus children can visually obtain impressions through single words and fixed pictures only, but cannot listen or learn the pronunciation of the words or other languages while reading a story, and cannot have the effect of displaying a change of pictures or animations. As a result, the learning effect achieved by reading the story books is very limited, and children may lose the interest of learning very soon due to the monotonous contents of the words and pictures.

Furthermore, traditional children story books are in a physical form of books whose large quantity of words and pictures are divided into volumes and published in series, so that the heavy book series not only occupies children's living space, but also creates a large learning pressure intangibly. Obviously, the traditional children story books are unable to use technologies to provide a diversified learning method to children. As to modern points of view, the traditional children story books actually constitute an obstacle to children's learning.

Therefore, it is a main subject of the present invention to develop a children's story audio/video playing device capable of playing words, pictures, animation images and sounds and allowing users to record the played audio content, such that a children story can be expressed in a diversified manner, so as to achieve the effect of a quick, simple, easy and convenient operation.

### SUMMARY OF THE INVENTION

In view of the aforementioned shortcomings of the prior art, the inventor of the present invention based on years of experience in the related industry to conduct extensive researches and experiments, and finally developed a children's story audio/video playing device in accordance with the present invention to play texts, graphics, animation images and sounds, record and play audio contents recorded by users, and achieve a quick, simple, easy and convenient operation.

Therefore, it is a primary objective of the present invention to provide a children's story audio/video playing device having a design capable of playing contents such as words, pictures, animation images and sounds of a children story, while allowing users to record the played audio content.

Another objective of the present invention is to provide a children's story audio/video playing device with a design having hardware operating devices installed at a front side of the children's story audio/video playing device for directly controlling contents displayed by the liquid crystal display, so as to achieve a quick, simple, easy and convenient operation.

To achieve the foregoing objectives, the present invention provides a children's story audio/video playing device comprising: a playing device body, including a main board, a display device, a speaker, an audio receiver, a user operating device, at least one connector and a power supply, wherein the main board includes a central processing unit, a display engine, an audio processing unit, a general purpose I/O, a USB host, memory card controller, and a power management controller. The children's story audio/video playing device further comprises a network controller, a direct memory access unit, a program storage unit, a real time clock unit, and a memory controller, for playing contents of children audio/video stories. The display engine is coupled to the central processing unit and the display device, and the audio processing unit is coupled to the central processing unit, the speaker and the audio receiver, and the general purpose I/O is coupled to the central processing unit and the user operating device, and the USB host and the memory card controller are coupled to the central processing unit and the connector, and the power management controller is coupled to the main board and the power supply. The user operating device includes a roller operating device and a press key operating device.

The children's story audio/video playing device of the present invention is capable of playing contents including words, pictures, animation images and sounds of a children story and allowing users to record the played audio content, so as to achieve the effect of a quick, simple, easy and convenient operation.

### BRIEF DESCRIPTION OF THE DRAWINGS

FIG. 1 is a perspective view of a preferred embodiment of the present invention;

FIG. 2 is a front view of a preferred embodiment of the present invention;

FIG. 3 is a side view of a preferred embodiment of the present invention;

FIG. 4 is a rear view of a preferred embodiment of the present invention;

FIG. 5 is a bottom view of a preferred embodiment of the present invention;

FIG. 6 is a block diagram of a preferred embodiment of the present invention; and

FIG. 7 is a schematic view of operating a page in accordance with a preferred embodiment of the present invention.

### DESCRIPTION OF THE PREFERRED EMBODIMENTS

To make it easier for the examiner to understand the objects, characteristics and effects of this invention, we use a preferred embodiment together with the attached drawings for the detailed description of the invention.

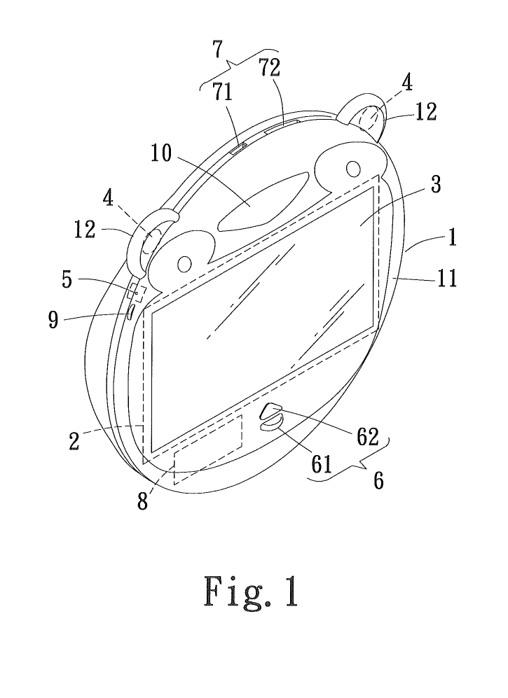

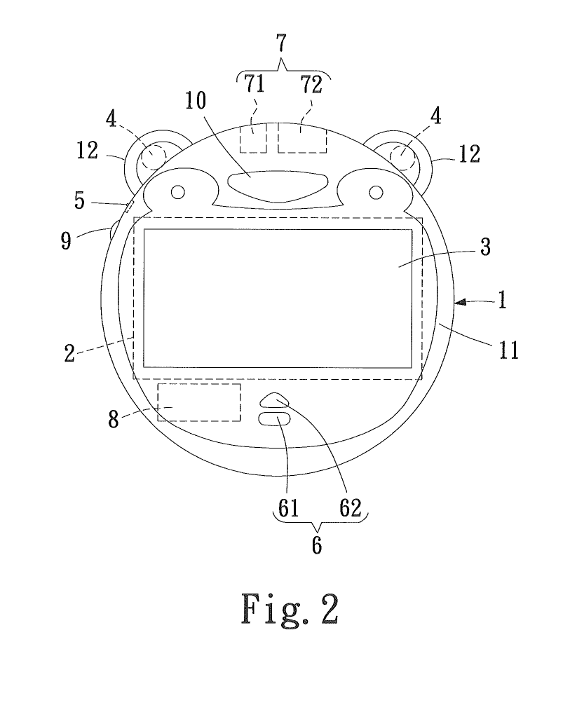

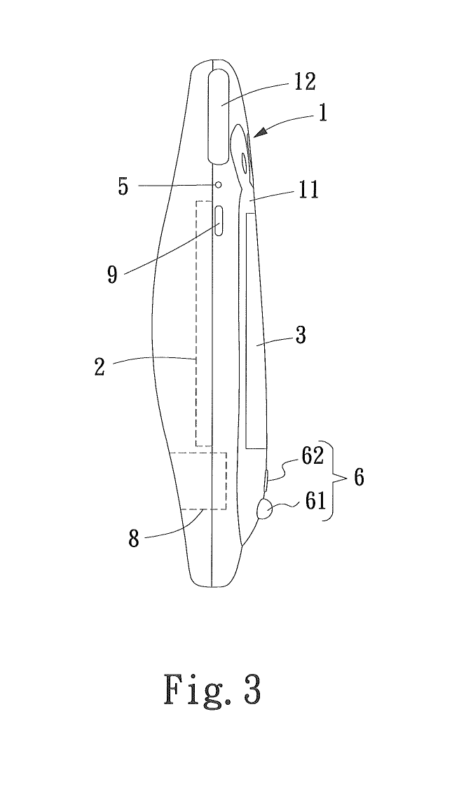

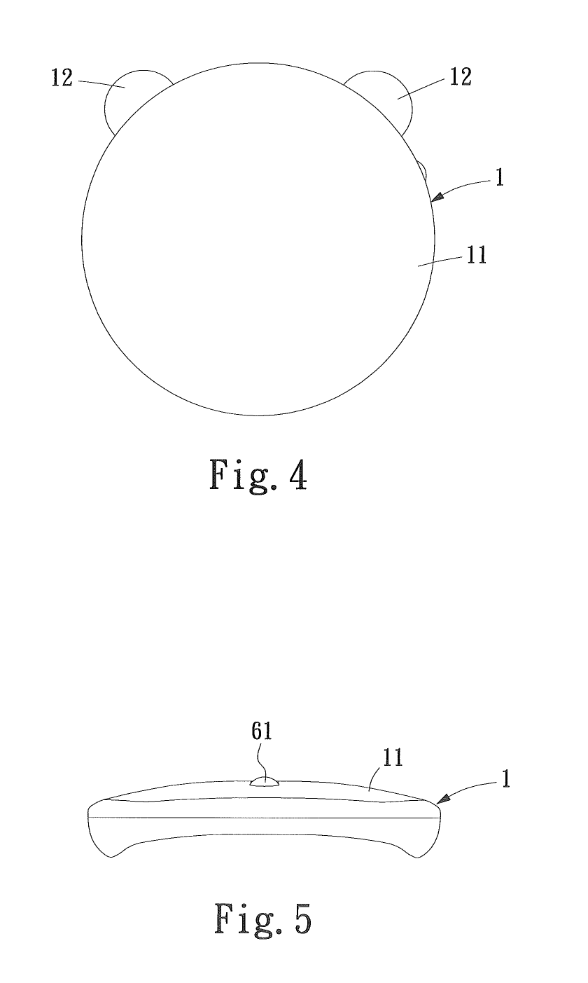

With reference to FIGS. 1 and 2 for a children's story audio/video playing device in accordance with a preferred embodiment of the present invention, the children's story audio/video playing device comprises: a playing device body 1, including a main board 2, a display device 3, at least one speaker 4, an audio receiver 5(MAC), a user operating device 6, at least one connector 7 and a power supply 8. In FIGS. 2 to 5, the playing device body 1 includes a casing 11 in a circular shape or any other shape, and two lugs 12 formed at the top of the casing 11, such that the playing device body 1 is substantially in the shape of an animal head. The main board 2 and the power supply 8 are coupled into the playing device body 1, and the display device 3 and the user operating device 6 are coupled to and exposed from a front side of the playing device body 1, and the speaker 4 is coupled into the lug 12 of the playing device body 1, and the audio receiver 5 and the connector 7 are installed on a side or any other selected position of the playing device body 1.

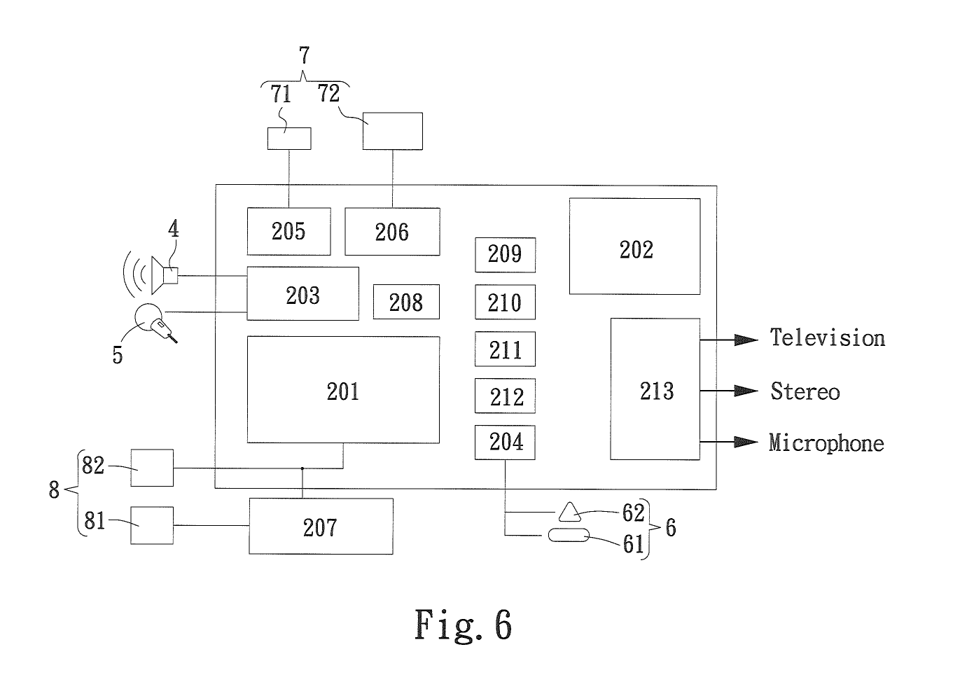

In FIG. 6, the main board 2 includes a central processing unit (CPU) 201, a display engine 202, an analog-to-digital/digital-to-analog (ADC/DAC) audio processing unit 203, a general purpose I/O 204, a universal serial bus (USB) host 205, a memory card controller 206, a power management controller 207. The children's story audio/video playing device further comprises a network controller 208 (PHY), a direct memory access (DMA) unit 209, a program storage unit 210 (which is a read only memory, ROM) for storing a power-on software program, a real time clock (RTC) unit 211, a memory controller 212, and an I/O interface 213 for outputting to an external television (TV), an external speaker and an external microphone (MAC). The central processing unit 201 is a 32-bit SIM DSP embedded processor, and the display engine 202 is coupled to the central processing unit 201 and the display device 3, and the audio processing unit 203 is coupled to the central processing unit 201, the speaker 4 and the audio receiver 5, and the general purpose I/O 204 is coupled to the central processing unit 201 and the user operating device 6, and the USB host 205 and the memory card controller 206 are coupled to the central processing unit 201 and the connector 7, and the power management controller 207 is coupled to the main board 2 and the power supply 8, such that the children's story audio/video playing device can play contents of a children audio/video story.

With reference to FIGS. 1 and 6 again for a preferred embodiment of the present invention, the display device 3 is a thin film transistor liquid crystal display (TFT-LCD) panel or a touch screen LCD panel for displaying words, pictures and animation images of a children story. The audio processing unit 203 is coupled to a sound volume control device 9 installed on a side of the playing device body 1 and provided for controlling a sound volume by users. The user operating device 6 comprises a roller operating device 61 and a press key operating device 62, wherein the roller operating device 61 is a hardware device including a roller and an optical module, such that when a user pushes and moves the roller, the optical module detects a rotation of the roller; and the press key operating device 62 is a hardware device including a press key and a circuit contact for switching a page displayed by the display device 3. The connector 7 includes at least a USB connector 71 and a memory card connector 72, and the USB connector 71 is provided for users to connect other peripheral hardware devices (such as a flash memory disk or an optical disk driver, etc), and the memory card connector 72 can be connected to a SD memory card, a CF memory card, or a memory card of another interface. The power supply 8 includes a power supply device 81 and a battery 82, wherein the power supply device 81 is provided for converting alternate current (AC) into direct current (DC) required for operating the children's story audio/video playing device of the present invention, and the battery 82 can be a rechargeable battery (such as a lithium ion battery), and the power management controller 207 is coupled to a power switch 10 installed onto the playing device body 1.

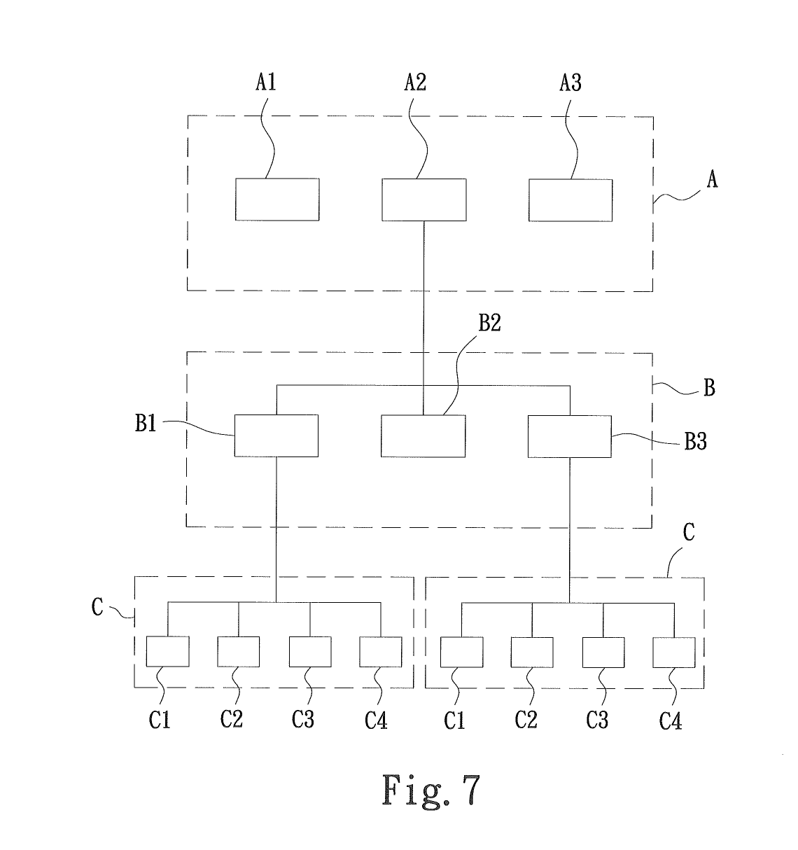

During the operation of the children's story audio/video playing device, the power switch 10 is pressed to load an operating system from the program storage unit 210 to enter into a power-on status of the audio/video playing device in order to display data of a children story stored in a flash memory disk connected to the USB connector 71, or stored in a memory card connected to the memory card connector 72, or stored a program storage unit 210 for viewing the data by the users. In FIG. 7, the display device 3 displays a main page A of the children story, wherein a plurality of main playing menus A1, A2, A3 . . . can be pre-installed in the contents of the main page A by a software program, wherein the main playing menus A1, A2, A3 of the main page A can be options such as fable stories, Chinese stories, classic stories, religious stories, and other stories provided for the users' choice. After a user enters into a secondary page of each main menu, a plurality of secondary playing menus B1, B2, B3 . . . can be pre-installed through the software program, wherein the secondary playing menus B1, B2, B3 . . . of the secondary page B can be a title, an author, a section or a chapter of a story provided for the users' choice. After the user enters into a tertiary page C of each secondary playing menu, a plurality of tertiary playing menus C1, C2, C3, C4 are provided, and the tertiary page C and the tertiary playing menus C1, C2, C3, C4 . . . are set with options “Chinese Voice”, “Foreign Language Voice”, “Recorded Voice” or “Start Recording” provided for the users' choice.

If a children user wants to switch the main playing menu display A1, A2 . . . and the secondary playing menu B1, B2 . . . , C1, C2 . . . in the aforementioned operating interface, the children user just needs to push and move the roller of the roller operating device 61 to achieve the effect of switching the playing menus. If the children user wants to click to enter into a playing menu A1, A2 . . . , B1, B2 . . . , C1, C2 . . . , the children user just needs to press the roller of the roller operating device 61 to enter into a secondary or tertiary page B, C, or the children user selects “Chinese Voice”, “Foreign Language Voice”, “Recorded Voice” from the tertiary page C to enter into a playing status, or selects “Start Recording” to enter into a recording mode. If the children user wants to return to a previous page A or B, then the children user just needs to press the press key of the press key operating device 62 to return the screen to the desired previous page A or B.

By the aforementioned operation, the children's story audio/video playing device of the invention can play contents of the children story including words, pictures, animation images, Chinese voices, foreign language voices or any voice recorded by the users, such that the children story can be expressed in a diversified manner to enhance the fun and the learning effect of reading the children story. The users can also click to enter into a “recording mode”, so that the audio receiver 5 can record audios of the children story recited by the users and store the audios into the flash memory disk, the memory card or the program storage unit 210 for playing the audios for the next time. With the design of the roller operating device 61 and the press key operating device 62, the children's story audio/video playing device of the present invention simplifies the operating hardware interface to achieve a quick simple, easy and convenient application which is particularly suitable for children to read and listen to a children story.

In summation of the description above, the children's story audio/video playing device of the present invention comes with a design capable of playing contents such as words, pictures, animation images and sounds of a children story and allowing users to record the played audio contents, so as to achieve the effect of a quick, simple, easy and convenient operation. In addition, products derived by the method of the invention can meet the market requirements, and the present invention complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A children's story audio/video playing device, comprising a playing device body including a main board, a display device, a speaker, an audio receiver (MAC), a user operating device, at least one connector and a power supply, and the main board including a central processing unit (CPU), a display engine, an audio processing unit (Audio ADC/DAC), a general purpose I/O, a universal serial bus (USB) host, a memory card controller, a power management controller, a network controller (PHY), a direct memory access unit (DMA), a program storage unit (Read Only Memory, ROM), a real time clock (RTC) unit, and a memory controller, for playing contents of a children audio/video story.

2. The children's story audio/video playing device of claim 1, wherein the display engine is coupled to the central processing unit and the display device, and the audio processing unit is coupled to the central processing unit, the speaker and the audio receiver, and the general purpose I/O is coupled to the central processing unit and the user operating device, and the USB host and the memory card controller are coupled between the central processing unit and the connector, and the power management controller is coupled to the main board and the power supply.

3. The children's story audio/video playing device of claim 2, wherein the display device is a liquid crystal display (LCD) panel or a touch LCD panel.

4. The children's story audio/video playing device of claim 2, wherein the audio processing unit is coupled to a sound volume control device installed on the playing device body.

5. The children's story audio/video playing device of claim 2, wherein the user operating device comprises a roller operating device and a press key operating device.

6. The children's story audio/video playing device of claim 2, wherein the connector includes a USB connector and a memory card connector.

7. The children's story audio/video playing device of claim 2, wherein the power supply includes a power supply device and a battery.

8. The children's story audio/video playing device of claim 2, wherein the power management controller is coupled to a power switch installed on the playing device body.

9. The children's story audio/video playing device of claim 6, wherein the memory card connector is coupled to a SD memory card or a CF memory card.

10. The children's story audio/video playing device of claim 1, wherein the main board further includes an I/O interface for outputting to an external stereo and an external microphone.
